(19) United States
(12) Patent Application Publication
(10) Pub. No.: US 2011/0278896 A1
(43) Pub. Date: Nov. 17, 2011

(54) ADJUSTING DEVICE FOR ADJUSTING A BACKREST OF A VEHICLE SEAT

(75) Inventors: Martin STEIN, Guntersblum (DE); Juergen MAIER, Weitersweiler (DE)

(73) Assignee: GM GLOBAL TECHNOLOGY OPERATIONS LLC, Detroit, MI (US)

(21) Appl. No.: 13/099,984

(22) Filed: May 3, 2011

(30) Foreign Application Priority Data
May 14, 2010 (DE) 102010020558.3

(51) Int. Cl. B60N 2/22; B60N 2/20

(52) U.S. Cl. 297/354.12

(57) ABSTRACT

An adjusting device for adjusting an inclination angle of a backrest of a vehicle seat, in particular for a motor vehicle, wherein the adjusting device is arranged inside the vehicle seat.

### CROSS-REFERENCE TO RELATED APPLICATION

This application claims priority to German Patent Application No. 102010020558.3, filed May 14, 2010, which is incorporated herein by reference in its entirety.

### TECHNICAL FIELD

The technical field is generally related to an adjusting device for adjusting an inclination angle of a backrest of a vehicle seat, in particular for a motor vehicle.

### BACKGROUND

A stepless adjusting device has the advantage over a non-stepless adjusting device that the space in the vehicle interior can be better utilized since the distance between an operating lever for actuating the adjusting device and a B-pillar can be smaller than between a hand wheel and the B-pillar in the case of the non-stepless adjusting device. Because up to now, the stepless adjusting device too is arranged laterally on the outside on the vehicle seat, the adjusting device requires a certain space. In addition, the adjusting device arranged on the outside has to be covered for optical reasons with a faceplate for which, in addition, a certain space is required.

Therefore, at least one object is to improve an adjusting device in such a manner that the same needs less space in the vehicle interior than previously. In addition, other objects desirable features and characteristics will become apparent from the subsequent summary and detailed description, and the appended claims, taken in conjunction with the accompanying drawings and this background.

### SUMMARY

An adjusting device is provided for adjusting an inclination angle of a backrest of a vehicle seat, in particular for a motor vehicle. The adjusting device is arranged inside the vehicle seat. Due to the arrangement of the adjusting device inside the vehicle seat, the adjusting device requires no longer any space in the vehicle interior. Thus, a faceplate for covering the adjusting device can also be eliminated. Consequently, through the adjusting device according to the invention, additional space is gained in the vehicle interior. It is only necessary to provide an operating lever on the outside of the vehicle seat for actuating the adjusting device if the backrest is not intended to be adjusted electrically, but manually.

In a preferred embodiment, the adjusting device is arranged inside the backrest. In this case, the operating lever is arranged laterally on the backrest so that the operating lever is moved together with the backrest when adjusting the inclination angle. Principally, the adjusting device can also be provided inside a seat body having a seat.

For reasons of space, a ratchet mechanism for actuating the adjusting device can also be arranged inside the vehicle seat. Preferably, the ratchet mechanism can also be accommodated in the backrest or alternatively in the seat body. When not in use, the operating lever arranged laterally on the vehicle seat for actuating the adjusting device or the ratchet mechanism can be moved into a parking position. For this purpose, the operating lever can rest tightly against the vehicle seat or can be embedded in a recess provided in the upholstery of the seat.

On the operating lever, a drive rod can be provided which extends into the inside of the vehicle seat and at the end of which, a toothed circular segment-like transmission element is arranged which engages with a further toothed circular segment-like transmission element, wherein the further transmission element drives the ratchet mechanism or the adjusting device. Thus, the operating lever can be arranged in an operator-friendly manner at a higher position on the side of the backrest.

In order to be able to move the operating lever into the parking position when the same is not in use, the transmission elements can be coupled together or decoupled from another. In order to be able to position the operating lever as high as possible on the backrest, the drive rod provided on the operating lever and extending into the inside of the vehicle seat can be connected to the ratchet mechanism or the adjusting device by means of a circulating belt or a circulating chain or the like. In an alternative embodiment, for the same reason, the drive rod provided on the operating lever and extending into the inside of the vehicle seat can be connected to the ratchet mechanism or the adjusting device by means of an extension rod.

A vehicle seat is also provided, in particular for said motor vehicle, having the adjusting device according to the embodiments. In addition, a motor vehicle with the vehicle seat is provided according to the embodiments.

### BRIEF DESCRIPTION OF THE DRAWINGS

The present invention will hereinafter be described in conjunction with the following drawing figures, wherein like numerals denote like elements, and:

FIG. 1 shows a perspective top view from the inside of a first embodiment of the adjusting device in a first operating state;

FIG. 2 shows a perspective top view from the outside of the first embodiment in the first operating state;

FIG. 3 shows a perspective top view from the outside of the first embodiment of the adjusting device in a second operating state;

FIG. 4 shows a perspective top view from the inside of the first embodiment of the adjusting device in the second operating state;

FIG. 5 shows a perspective top view of a second embodiment of the adjusting device; and

FIG. 6 shows a perspective top view of a third embodiment of the adjusting device.

### DETAILED DESCRIPTION

The following detailed description is merely exemplary in nature and is not intended to limit application and uses. Furthermore, there is no intention to be bound by any theory presented in the preceding background or summary or the following detailed description.

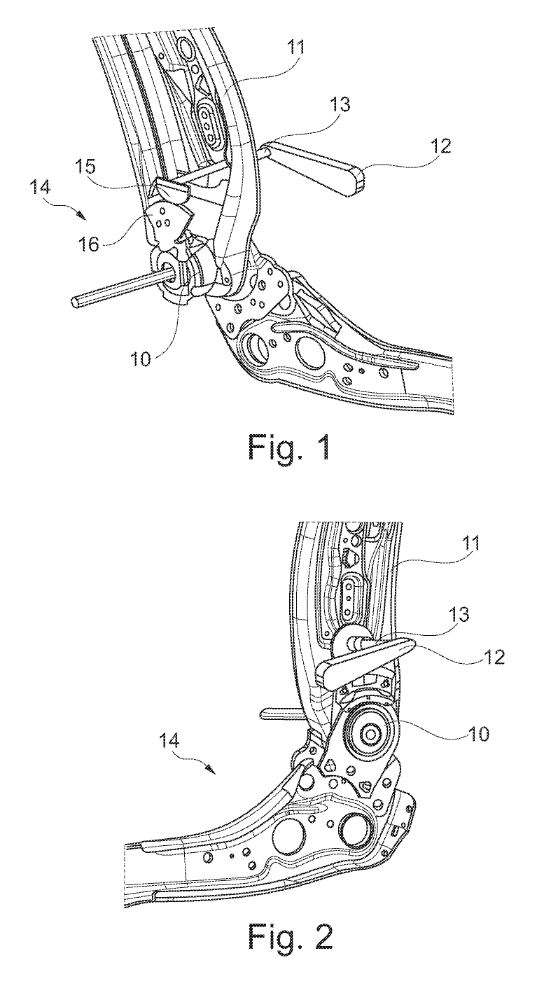

The FIG. 1 and FIG. 2 show an adjusting device 10 for adjusting an inclination angle of a backrest 11 of a vehicle seat 14. For adjusting the inclination angle, an operating lever 12 is actuated on which a drive rod 13 is arranged. On the drive rod 13 inside the backrest 11, a circular segment-like transmission element 15 is arranged which is toothed on its circumference and engages with a transmission element 16 which is formed toothed as well. The transmission element 16 actuates a ratchet mechanism which is covered here and which in turn drives the adjusting device 10.

The operating lever 12 is positioned above the adjusting device 10 so that the same can easily be reached by a person.

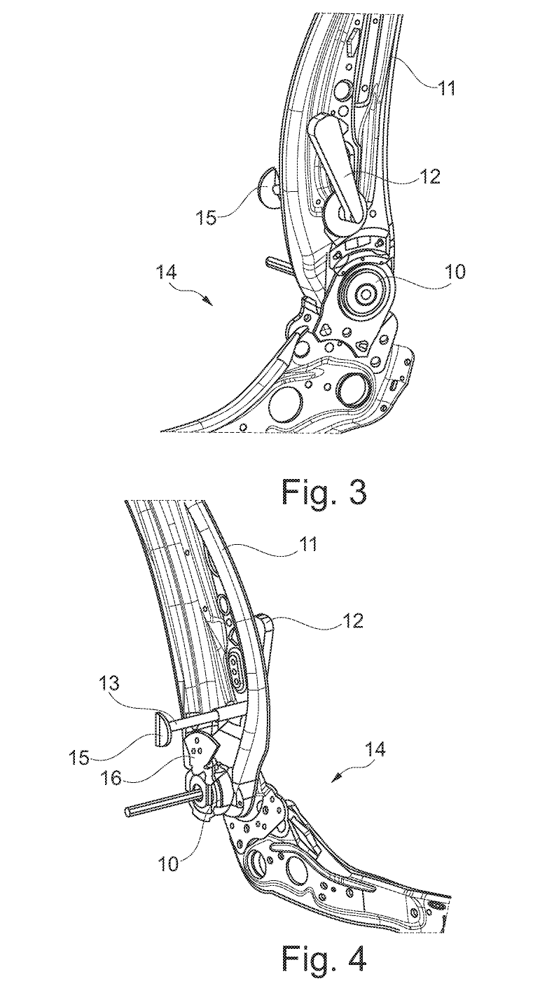

The FIG. 3 and FIG. 4 show the adjusting device 10, wherein the transmission elements 15 and 16 are not in engagement. When the operating lever 12 is not in use, the same can be displaced into a parking position so that the transmission elements 15 and 16 are decoupled.

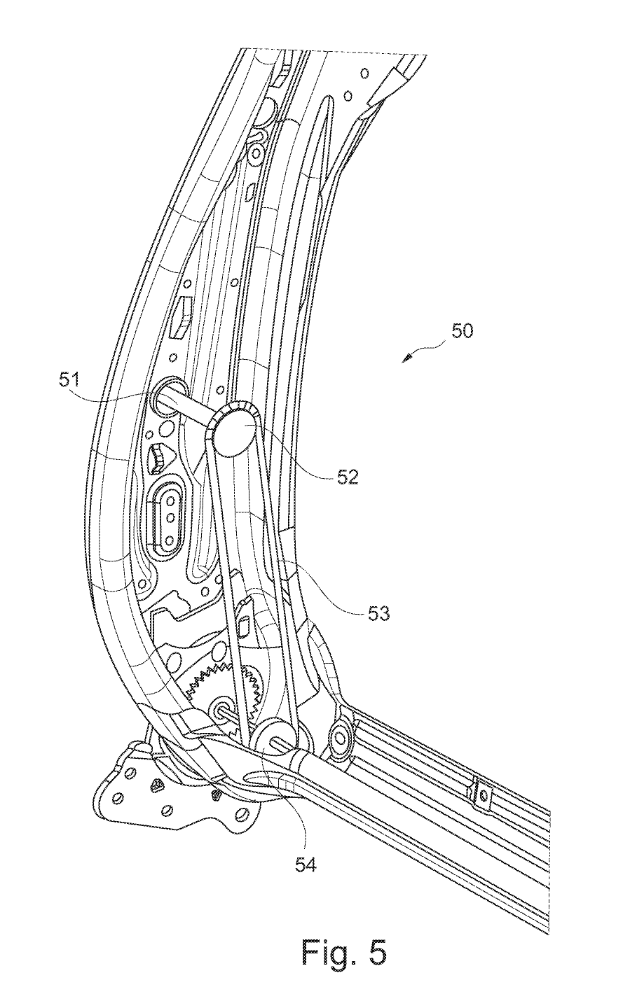

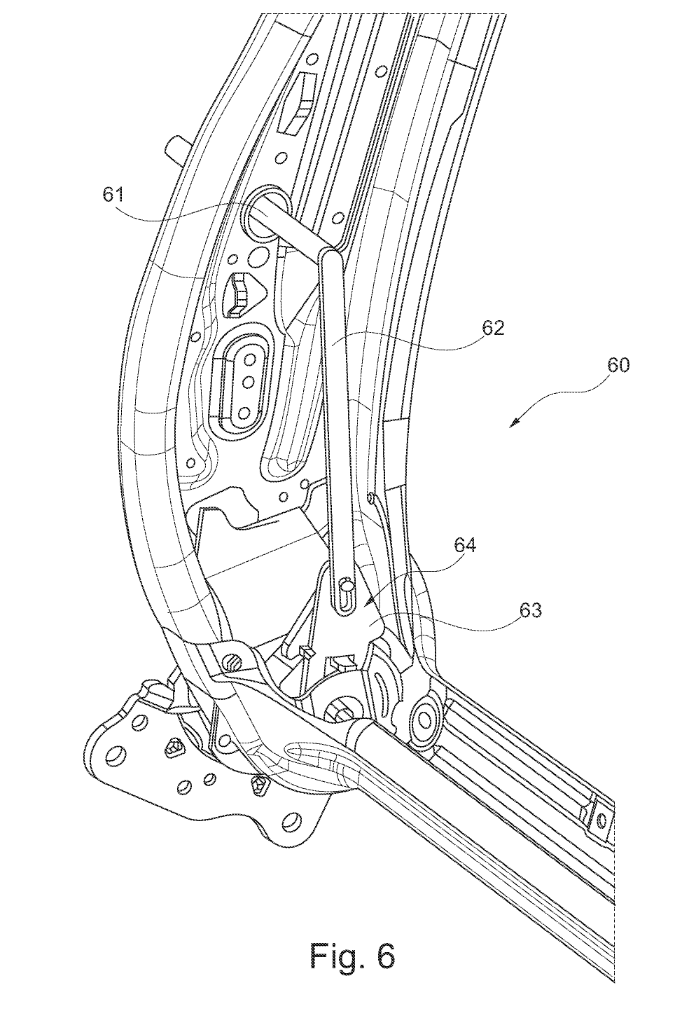

A vehicle seat 50 has a drive rod 51 at the covered end of which the lever is attached and on which a belt wheel 52 is provided around which an endlessly circulating belt 53 runs (see FIG. 5). The belt 53 runs in addition around a belt wheel 54 which can drive the adjusting device or the ratchet mechanism which is not visible in detail here. Due to the circulating belt 53, the lever can be attached in an operator-friendly manner above the adjusting device.

A vehicle seat 60 has a drive rod 61 on which the lever is arranged which is also covered here and on which an extension rod 62 is attached which is connected via a cam 63 to the adjusting device or ratchet mechanisms which is also not visible here. At its end facing the cam 63, the extension rod 62 has an elongated hole 64 so that the extension rod 62 can be pivoted.

Although above at least one exemplary embodiment has been explained, it goes without saying that there is still a high number of further embodiments. It should be emphasized that the at least one exemplary embodiment is not intended to limit the scope, the field of use or the exact configuration in any way. Instead, the preceding description is only meant to provide a guide for the person skilled in the art so as to be able to implement at least one exemplary embodiment. Of course, many alternatives with respect to function and arrangement of the described elements are possible without departing from the scope of the following claims.

What is claimed is:

1. A seat device, comprising:
a vehicle seat;
a backrest of the vehicle seat having and adjustable inclination angle of a backrest of a vehicle seat; and
an adjusting device that is arranged inside the vehicle seat and configured to adjust the adjustable angle of the backrest.

2. The adjusting device according to claim 1, wherein the adjusting device is arranged inside the backrest.

3. The adjustment device according to claim 1, further comprising a ratchet mechanism that is arranged inside the vehicle seat and configured to actuate the adjusting device.

4. The adjusting device according to claim 1, further comprising an operating lever arranged laterally on the vehicle seat that is configured to actuate the adjusting device.

5. The adjusting device according to claim 4, further comprising:
a drive rod on the operating lever, the drive rod extends into the inside of the vehicle seat; and
a toothed circular segment-like transmission element that is arranged on an end that is configured to engage with a second toothed circular segment-like transmission element configured to drive the adjusting device.

6. The adjusting device according to claim 5, wherein the toothed circular segment-like transmission element and the second toothed circular segment-like transmission element are configured to couple.

7. The adjusting device according to claim 5, wherein the toothed circular segment-like transmission element and the second toothed circular segment-like transmission element are configured to decouple.

8. The adjusting device according to claim 5, wherein the toothed circular segment-like transmission element and the second toothed circular segment-like transmission element are configured to couple.

9. The adjusting device according to claim 1, wherein the drive rod on the operating lever and extending into the inside of the vehicle seat is connected with a circulating belt the adjusting device.

10. The adjusting device according to claim 1, wherein the drive rod on the operating lever and extending into the inside of the vehicle seat is connected with a circulating chain to the adjusting device.

11. The adjusting device according to claim 1, wherein the drive rod on the operating lever and extending into the inside of the vehicle seat is connected with an extension rod to the adjusting device.

12. The adjusting device according to claim 1, wherein the drive rod on the operating lever and extending into the inside of the vehicle seat is connected with a circulating belt the ratchet mechanism.

13. The adjusting device according to claim 1, wherein the drive rod on the operating lever and extending into the inside of the vehicle seat is connected with a circulating chain to the ratchet mechanism.

14. The adjusting device according to claim 1, wherein the drive rod on the operating lever and extending into the inside of the vehicle seat is connected with an extension rod to the ratchet mechanism.
